(19) United States
(12) Patent Application Publication
(10) Pub. No.: US 2005/0159669 A1
(43) Pub. Date: Jul. 21, 2005

(54) Domestic area telephone system and operating method for automatic reminder generation

(76) Inventor: Klaus Abraham-Fuchs, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 10/983,113

(22) Filed: Nov. 5, 2004

(30) Foreign Application Priority Data
Nov. 7, 2003 (DE) 103 52 015.5

(51) Int. Cl. H04M 11/00

(52) U.S. Cl. 600/544

(57) ABSTRACT

In a telephone system for domestic area and operating method therefor, the telephone system outputs predeterminable signals (respectively associated with a predeterminable message) perceptible by a person at predeterminable points in time. The content of the messages, the type of the signals to be output and the points in time are stored in an editable form in a databank. The databank is stored in the telephone system or in a computer of the domestic area connectable with the telephone system.

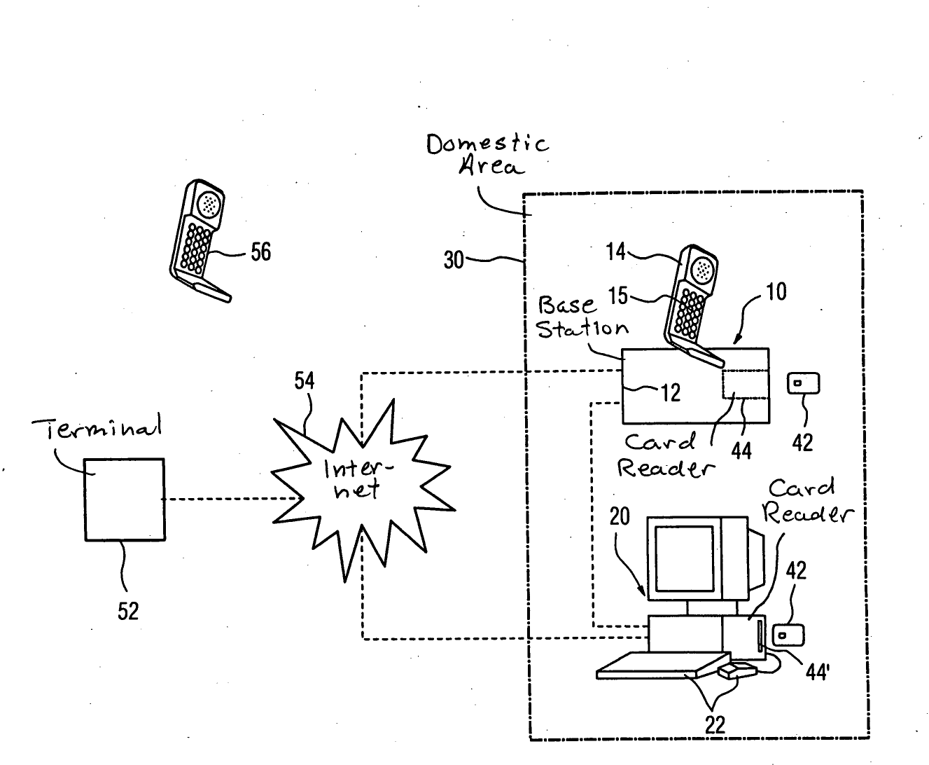

### BACKGROUND OF THE INVENTION

1. Field of the Invention

The present invention concerns a method for the operation of a telephone system in a domestic area and a telephone system to implement the method.

2. Description of the Prior Art

From German OS 197 50 139, a system is known for the as-needed generation of a signal perceptible by a person at one or more predetermined points in time at which one or more medicines must be taken or a time-constrained medical measure must be implemented. The system is arranged in a building. The system includes a control device provided with a time measurement device. The control device is mounted or attached at a first location within the building and which is activated or can be activated at the signaling point or points in time. The system also has a signal device, external to the control device, that is mounted or can be placed within or in a region of the building at a second location and communicates with the control device via a communication connection, which causes time-dependent signal to be generated if necessary by means of a command from the control device.

In German OS 198 52 602, a device to store medicines is described that emits a warning signal when the extraction of medicines ceases. The house communication system disclosed in this context has no databank and is merely used to output the warning signal.

In German OS 100 46 762, a mobile telephone (cell phone) is disclosed on which data for medicine administration are entered by the patient. The data entry that produces the reminder generation ensues via a special telephone card, calling a telephone hotline or WAP service.

In German OS 199 15 671, a medical monitoring system is described that has a reminder device separate from the telephone system that reminds the user via a message on the telephone system to take specific medicines. The telephone signal is used only to output the warning signal. A communication connection to the telephone system therefore must be established by the reminder device each time a warning instruction or a signal is emitted to the user regarding taking a medicine.

### SUMMARY OF THE INVENTION

An object of the invention is to provide a simple reminder system compared to the known systems described above.

This object is achieved in accordance with the invention by a method for the operation of a telephone system in a domestic area wherein the telephone system outputs predeterminable signals (respectively associated with a predeterminable message) perceptible by a person at predeterminable points in time.

An automated output of time-controlled messages within a telephone system of the domestic area is thereby realized.

### DESCRIPTION OF THE DRAWING

The single FIGURE is a schematic illustration of a telephone system constructed and operating in accordance with the principles of the present invention.

### DESCRIPTION OF THE PREFERRED EMBODIMENT

As an exemplary embodiment of the invention, the FIGURE shows a telephone system 10 in the domestic area 30. The telephone system 10 includes a base station 12 and a mobile component 14. In one embodiment, the telephone system 10 can be connected with a computer 20 arranged inside the domestic area 30.

A databank that is exemplarily and typically structured according to the following table is stored in the telephone system 10, in particular in its base station 12 or in the computer 20 that can be connected with the telephone system 10:

| | | Signal repetition | | | |
|---|---|---|---|---|---|
| | Repetition | interval given | | Devices | Type |
| | interval in | lack of | | to be | of |
| Time | days | acknowledgment | Message | notified | signal |
| 08:00 | 1 | 20 min | Take 2 | Mobile | Tone A and |
| | | | tablets of | part and | SMS |
| | | | antibiotic | base | |
| | | | X | station | |
| 19:00 | 1 | 20 min | Take 2 | Mobile | Tone A and |
| | | | tablets of | part and | SMS |
| | | | antibiotic | base | |
| | | | X | station | |
| 22:00 | 3 | 5 min | Change | Base | Speech |
| | | | dressing | station | announce- |
| | | | of the | | ment |
| | | | burn | | |
| . . . | . . . | . . . | . . . | . . . | . . . |

The contents of the databank can be editable via an input device 22 of the computer 20 (shown in the embodiment as a keyboard and/or mouse) or via an input device of the telephone system 10, for example the keypad 16 of the mobile component 15. The output of a message can be an arbitrary combination of a selectable tone, a speech announcement of the message and/or an SMS message (Short Message Services). Using a typical call-rerouting function, the message also can be forwarded to a telephone device 56 outside of the domestic area 30 or to a cell phone.

In an embodiment, the databank is also editable by medical specialist personnel and/or medical operators, for example a personal physician or a nursing service by password-protected access to the databank via a data line via terminal 52, for example via the Internet 54. In another embodiment, the data of the databank can also be stored in an electronic patient record of the user, for example in the terminal 52, and be loaded by authorization into a storage of the telephone system 10 or of the computer 20 as excerpts of the electronic patient record by means of a data line, for example the Internet 54.

In another embodiment, the data prepared by a medical specialist can be stored on a chip card 42 via medical treatment instructions and be transferred into the telephone system 10 or the computer 20 by means of a card reader 44 or 44′.

In another embodiment, an input key of the keypad 16 of the mobile part 15 can be defined with which the execution of the treatment instruction can be acknowledged with yes or be at least temporarily declined with “no”, and if applicable a new reminder can be triggered at a predefined time interval. In an embodiment, the acknowledgment information input at the telephone system 10 can be stored in the databank together with a time stamp and an association with the corresponding message, such that a retrievable documentation of the time curve of medical treatments is created.

The preceding description, which is exemplary for medical treatment instructions, is also suitable for other regularly repeating treatments in the domestic area, for example watering flowers. In other embodiments, the telephone system has, for example, no mobile component or is equipped with a number of mobile components.

Although modifications and changes may be suggested by those skilled in the art, it is the intention of the inventor to embody within the patent warranted hereon all changes and modifications as reasonably and properly come within the scope of his contribution to the art.

1. A method for operating a telephone system in a domestic area, said telephone system having a base station at said domestic area and said domestic area also encompassing a computer accessible by said base station, said method comprising the steps of:
in a databank accessible by at least one of said base station and said computer, storing, in editable form, at least one message having a message content, a signal type and a point-in-time associated therewith, each of said message content, said signal type and said point-in-time being editable; and
at said point-in-time, automatically emitting said message content via an output unit of the telephone system, as a humanly perceptible signal having said signal type.

2. A method as claimed in claim 1 comprising storing medical treatment instructions in said databank as said message content of said message in said databank.

3. A method as claimed in claim 1 wherein said telephone system is able to access a further output unit, outside of said domestic area, and comprising re-routing said message at said point-in-time, via said base station, to said further output unit.

4. A method as claimed in claim 1 comprising, at said output unit, allowing a positive or negative input to said telephone system after said point-in-time at which said message content is emitted and, given a negative input, repeating emission of said message content after a predetermined time.

5. A method as claimed in claim 1 comprising selecting said signal type from the group consisting of tones, speech elements and text.

6. A method as claimed in claim 1 wherein said telephone system includes an input device, and comprising connecting said input device to said databank and allowing editing of said message in said databank via said input device.

7. A method as claimed in claim 1 comprising connecting said computer with said databank, and allowing editing of said message in said databank via said computer.

8. A method as claimed in claim 1 comprising loading said databank into said telephone system from a location outside of said domestic area.

9. A method as claimed in claim 8 comprising loading said databank via the internet.

10. A method as claimed in claim 1 comprising loading said databank into said computer from a location outside of said domestic area.

11. A method as claimed in claim 10 comprising loading said databank via the Internet.

12. A method as claimed in claim 1 comprising deriving said message in said databank from an electronic patient record.

13. A method as claimed in claim 1 wherein said telephone system has an input device, and comprising the additional steps of allowing a positive or negative input via said input device after said message content is emitted, and storing said positive or negative input in said databank associated with a time indicator.

14. A telephone system comprising:
a base station located in a domestic area;
an output unit in communication with said base station; and
a databank accessible by said base station containing a message having a message content, a signal type and a point-in-time associated therewith, said message content, said signal type and said point-in-time being editable in said databank, said base station causing emission of said message content in humanly perceptible form via said output unit at said point-in-time with said signal type.
